(19) United States
(12) Patent Application Publication
(10) Pub. No.: US 2025/0218440 A1
(43) Pub. Date: Jul. 3, 2025

(54) CONTEXT-BASED SPEECH ASSISTANCE

(71) Applicant: Sorenson IP Holdings, LLC, Salt Lake City, UT (US)

(72) Inventor: Madison Skov, Auroa, CO (US)

(21) Appl. No.: 18/399,941

(22) Filed: Dec. 29, 2023

(51) Int. Cl. G10L 15/26; G10L 15/22

(52) U.S. Cl. CPC G10L 15/26; G10L 15/22; G10L 2015/225

(57) ABSTRACT

A method may include obtaining audio that includes speech of a user. The method may also include acquiring, in real-time, a transcription of the audio. The transcription may include text of the speech in the audio. The method may further include obtaining a prediction based on the transcription of the audio. The prediction may include one or more words that are predicted to follow a last word in the transcription and the prediction may be continuously updated in response to continuous updates to the transcription. The method may also include presenting the prediction to the user such that the presented prediction continuously changes in response to continuous updates to the transcription.

### FIELD

The embodiments discussed herein are related to context-based speech assistance.

### BACKGROUND

A speech nonfluency or disfluency refers to a break or irregularity that occurs during speech. For example, a speech disfluency can include a pause in speech or the user of a filler word, such as “huh,” “um,” or “uh.” A speaker may encounter a speech disfluency when the speaker pauses to recollect a particular detail, or forgets what they were going to say next. Disorders affecting the brain, such as aphasia, can result in abnormal speech and increase the likelihood of speech disfluencies.

The subject matter claimed herein is not limited to embodiments that solve any disadvantages or that operate only in environments such as those described above. Rather, this background is only provided to illustrate one example technology area where some embodiments described herein may be practiced.

### SUMMARY

A method may include obtaining audio that includes speech of a user. The method may also include acquiring, in real-time, a transcription of the audio. The transcription may include text of the speech in the audio. The method may further include obtaining a prediction based on the transcription of the audio. The prediction may include one or more words that are predicted to follow a last word in the transcription and the prediction may be continuously updated in response to continuous updates to the transcription. The method may also include presenting the prediction to the user such that the presented prediction continuously changes in response to continuous updates to the transcription.

### BRIEF DESCRIPTION OF THE DRAWINGS

Example embodiments will be described and explained with additional specificity and detail through the use of the accompanying drawings in which:

FIG. 1 illustrates an example environment for context-based speech assistance;

FIGS. 2a and 2b illustrate examples of context-based speech assistance;

FIG. 3 illustrates an example device used in context-based speech assistance;

FIG. 4 illustrates an example display used in context-based speech assistance;

FIG. 5 illustrates a flowchart of an example method for context-based speech assistance; and

FIG. 6 illustrates an example system that may be used during context-based speech assistance.

### DESCRIPTION OF EMBODIMENTS

A speech disfluency, such as non-fluent aphasia, may include a break or irregularity that occurs during speech. In some circumstances, a speech disfluency may cause a speaker to pause to recollect a particular detail or forget what the speaker was going to say next. A speech disfluency may occur for a multitude of reasons. For example, a traumatic brain injury or other brain disorders may result in a speech disfluency. Other times stress, excitement, being rushed, or other emotions may result in a speech disfluency. According to experienced speech and language practitioners, individuals with speech disfluency may recognize a word or phrase they desire to say when presented with the word or phrase.

The present disclosure relates generally to systems and methods that may prompt a speaker when the speaker encounters a speech disfluency. For example, one or more words or phrases may be presented to a speaker to help the speaker determine the next word or phrase to speak. As an example, if a speaker is in a conversation and encounters a speech disfluency, prompting the speaker with a word or phrase may assist the speaker to complete their thought. As such, the present disclosure may assist a user to be more articulate during a conversation.

In some embodiments, to be able to prompt a user, speech of the user may be monitoring continuously. The speech may be transcribed and presented to the user. Alternately or additionally, for each word spoken by the user, one or more words subsequent words may be predicted in real-time and presented to the user. The predicted words may be generated based on the transcription and presented along with the transcription. Thus, during a conversation, predicted words may appear on a rolling basis as the user speaks. The predicted words may help the user to determine the next word in their speech and thereby reduce their speech disfluency.

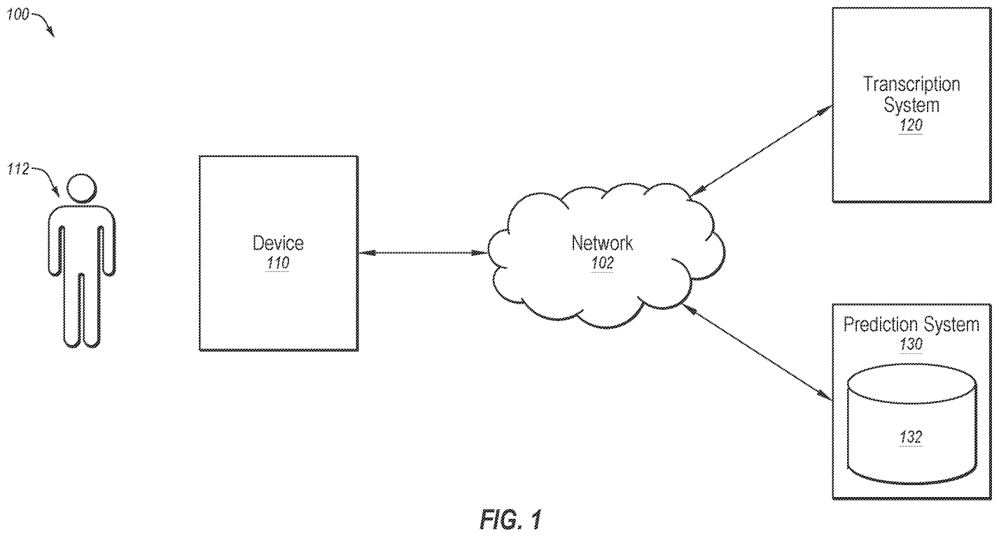

Turning to the figures, FIG. 1 illustrates an example environment 100 for context-based speech assistance. The environment 100 may be arranged in accordance with at least one embodiment described in the present disclosure. The environment 100 may include a network 102, a device 110, a user 112, a transcription system 120, and a prediction system 130.

The network 102 may be configured to communicatively couple the device 110, the transcription system 120, and the prediction system 130. In some embodiments, the network 102 may be any network or configuration of networks configured to send and receive communications between systems and devices. In some embodiments, the network 102 may include a wired network, an optical network, and/or a wireless network, and may have numerous different configurations, including multiple different types of networks, network connections, and protocols to communicatively couple devices and systems in the environment 100. In some embodiments, the network 102 may also be coupled to or may include portions of a telecommunications network, including telephone lines.

In some embodiments, the device 110 may include or be any electronic or digital computing device or system. For example, the device 110 may include a desktop computer, a laptop computer, a smartphone, a mobile phone, a tablet computer, or any other computing device that may include a microphone and a display. In some embodiments, the device 110 may include memory and at least one processor, which are configured to perform operations as described in this disclosure, among other operations. In some embodiments, the device 110 may include computer-readable instructions that are configured to be executed by the device 110 to perform operations described in this disclosure.

In some embodiments, the device 110 may be configured to obtain audio of the user 112. The audio may be part of a video format or only audio. The audio may include speech of the user 112. The speech of the user may be one or more verbalized words that may be spoken by the user 112. The speech may be obtained by the device 110 on a continuous basis, in response to an input from the user, and/or in response to one or other inputs obtained by the device 110. For example, the device 110 may monitoring for one or more keywords to start obtaining speech. The device 110 may obtain the speech in real-time as the user 112 speaks.

In some embodiments, the device 110 may be configured to obtain a transcription of the speech. The transcription may include a written form of words, for example text, that may be included in the speech of the audio obtained by the device 110. In some embodiments, the device 110 may be configured to obtain a transcription of the speech in real-time as the user speaks. In some embodiments, real-time may be within 1, 2, 3, 5, or 10 seconds from when the device 110 obtains the audio. In these and other embodiments, the transcription may be a continuous transcription of the audio as the audio is obtained by the device 110. For example, as the user 112 says a sentence during a time interval of T0 to T3, the device 110 may obtain audio that includes a first word of the sentence at time T1 and obtain a transcription of the first word between the time interval T0 and T3.

In some embodiments, the device 110 may be configured to present the transcription of the audio. For example, the device 110 may present the transcription on a display of the device to the user 112. In these and other embodiments, the device 110 may present the transcription in real-time. Following the previous example, the device 110 may be configured to present the first word obtained at time T1 at time T2 during the time interval T0 to T3 when the user 112 is saying the sentence. The device 110 may update the presentation of the transcription of the audio as more audio is obtained with more speech. Thus, the transcription may be presented on a rolling-basis as words are spoken, audio obtained, a transcription obtained, and the transcription presented.

In some embodiments, the device 110 may provide the audio to the transcription system 120. In these and other embodiments, the device 110 may obtain the transcription of the audio from the transcription system 120.

In some embodiments, the transcription system 120 may be configured to obtain the audio from the device 110. For example, the transcription system 120 may obtain the audio from the device 110 over the network 102. The transcription system 120 may be configured to generate a transcription of the audio. The transcription system 120 may provide the transcription of the audio to the device 110.

In some embodiments, the transcription system 120 may be configured to generate a transcription of audio using automatic speech recognition (ASR). In some embodiments, the transcription system 120 may use fully machine-based ASR systems that may operate without human intervention. Alternately or additionally, the transcription system 120 may be configured to generate a transcription of audio using a revoicing transcription system. The revoicing transcription system may receive and broadcast audio to a human agent. The human agent may listen to the broadcast and speak the words from the broadcast. The words spoken by the human agent are captured to generate revoiced audio. The revoiced audio may be used by a speech recognition program to generate the transcription of the audio. Alternately or additionally, the transcription system 120 may be a combination of an ASR system and a revoicing system. Alternately or additionally, the transcription system 120 may be a combination of multiple ASR systems. In these and other embodiments, any technique may be used by the transcription system 120 to generate the transcription.

In some embodiments, the transcription system 120 may include any configuration of hardware, such as processors, servers, and database servers that are networked together and configured to perform a task, such as generation of a transcription from audio. For example, the transcription system 120 may include one or multiple computing systems, such as multiple servers that each include memory and at least one processor.

The device 110 may be configured to obtain the transcription from the transcription system 120. In response to obtaining the transcription, the device 110 may be configured to present the transcription to the user 112. Alternately or additionally, in response to obtaining the transcription, the device 110 may be configured to provide the transcription to the prediction system 130.

The prediction system 130 may be configured to obtain the audio from the device 110. For example, the prediction system 130 may obtain the transcription from the device 110 over the network 103. The prediction system 130 may be configured to generate a prediction based on the transcription of the audio. The prediction may include one or more words that are predicted to follow a last word in the transcription obtained by the prediction system 130. The prediction system 130 may provide the prediction to the device 110. The device 110 may obtain the prediction and present the prediction.

In some embodiments, the prediction may be continuously updated in response to continuous updates to the transcription. For example, every time there is an update to the transcription, a new prediction may be generated by the prediction system 130 using the update to the transcription. The device 110 may be configured to present a new prediction in place of the previous prediction. Thus, the user 112 saying a new word may result in the device 110 obtaining an updated transcription with the new word and an updated prediction for a word that may follow the new word. The device 110 may present the new word with the previous words from the transcription and may replace a previous prediction with the updated prediction.

In some embodiments, the prediction generated by the prediction system 130 may include multiple different sets of words. In these and other embodiments, each of the sets of words may include one or more words, such as a word or phrase. For example, the prediction system 130 may determine multiple sets of words that may follow the words previously spoken by the user 112. In these and other embodiments, the prediction may include a particular number of sets of words. For example, the prediction may include 2, 3, 4, 5, 6, 7, 8, 9, 10, or more sets of words that may follow the words previously spoken. Alternately or additionally, the prediction may include sets of words with a probability that the sets of words follow the words previously spoken that satisfy a threshold. For example, the prediction system 130 may determine 15 sets of words and 5 of the sets of words may have a probability that is above a threshold. In these and other embodiments, the prediction may include the 5 sets of words. In these and other embodiments, the sets of words may be provided to the device 110. The device 110 may be configured to present all, some, or none of the sets of words obtained from the prediction system 130.

In some embodiments, the prediction system 130 may include any configuration of hardware, such as processors, servers, and database servers that are networked together and configured to perform a task, such as generate predictions. For example, the prediction system 130 may include one or multiple computing systems, such as multiple servers that each include memory and at least one processor. For example, the prediction system 130 may include an artificial intelligence system that has been trained on a large amount of textual data to understand and generate human-like language prompts and responses. The prediction system 130 may also be designed to process and comprehend the complexities of natural language, including syntax, semantics, and context. In these and other embodiments, the prediction system 130 may comprehend the human language in different forms and languages and produce or predict human-like responses. As an example, the prediction system 130 may include or be similar to ChatGTP from OpenAI or may use a system similar to ChatGTP.

In some embodiments, the prediction system 130 may be configured to generate the prediction based on the speech of the user 112. For example, the prediction system 130 may consider the words previously spoken by the user 112 and may consider the most likely word or words to follow the words previously spoken. In these and other embodiments, the prediction system 130 may generate the prediction based on the word or words mostly likely to follow the words previously spoken.

In some embodiments, the prediction system 130 may use additional data to generate the prediction. For example, the user 112 may be conversing with another person. In these and other embodiments, second speech of the other person may be captured by the device 110. A second transcription of the second speech may be generated. The prediction system 130 may use the transcription of the speech of the user 112 and the second transcription to generate the prediction. In these and other embodiments, the second transcription may provide additional context to the speech of the user 112. As a result, the prediction may be more likely to include the next words that may be spoken by the user 112. In these and other embodiments, the prediction may include one or more words that are predicted to follow a last word in the transcription or a last word in the second transcription obtained by the prediction system 130. The prediction system 130 may provide the prediction to the device 110. The device 110 may obtain the prediction and present the prediction. In these and other embodiments, the prediction system 130 may generate the prediction for speech of the user 112 and/or the second speech of the other person.

In some embodiments, the prediction system 130 may use feedback from the user 112 to generate the predictions. For example, the user 112 may provide feedback in real-time as the prediction is presented. In response to the prediction not accurately predicting the next word or words of the user 112, the user 112 may provide an indication that the prediction is not accurate. The prediction system 130 may use the feedback of the user 112, the context of the transcription, and/or other data to update the algorithm to generate predictions more likely to be accurate in the future. Alternately or additionally, in response to feedback from the user 112 of the predictions not being accurate, the prediction system 130 may generate a new prediction for the transcription. For example, the transcription may read “I like to read” and the prediction may be the word “books.” Based on the feedback that the prediction of “books” is not accurate, the prediction system 130 may generate an updated prediction, such as “magazines,” and present the updated prediction. In these and other embodiments, the prediction may change even though there is not a change in the transcription.

In some embodiments, the feedback of the user 112 may be based on a review of the transcription by the user 112. For example, the user 112 may say a predicted word. As a result, the word may be captured in the audio and become part of the transcription. The user 112 may review the transcription to determine instances where the word the user said was not accurate or did not fully convey the intent of the user 112. In these and other embodiments, the user 112 may indicate the word was improper and/or provide an indication of the proper word. The prediction system 130 may be trained based on the feedback of the user 112. Alternately or additionally, during review of the transcription, the user 112 may select a word in the transcription to view the prediction that was provided to the user 112. The user 112 may indicate if the prediction was accurate for the word in the transcription. In these and other embodiments, the prediction system 130 may be trained using the feedback of the user 112.

In some embodiments, the device 110 may compare the next word in the transcription that corresponds with a prediction to determine if the transcription includes a word that was part of the prediction. For example, the prediction may include three words that may be the next word in the transcription. The user 112 may say a word that may become part of the transcription as a new word. The device 110 may compare the new word in the transcription with the three words of the prediction for the new word. Thus, the device 110 may determine if the user 112 selected to say one of the words provided as a prediction. When the user 112 selects one of the prediction words, the prediction may be determined to be accurate. When the user 112 does not select one of the prediction words, the prediction may be determined to not be accurate or less accurate. The device 110 may provide the accuracy of the prediction to the prediction system 130. The prediction system 130 may be trained using the feedback resulting from comparing the transcription and the predictions. For example, the prediction system 130 may be more likely to predict a word that the user 112 selects in the future than other words that the user does not select given the same context for a transcription.

In some embodiments, the prediction system 130 may use information about the user 112 to generate the prediction. For example, information about the user 112 may be stored in a data storage 132. The information may include an age, demographic, spoken language, current living location, location where the user 112 was raised, education, and vocation, among other information about the user 112.

In some embodiments, the prediction system 130 may use a current physical location of the user 112 to generate predictions. For example, the prediction system 130 may obtain a current physical location of the user 112 and may determine what is at the physical location. Based on the physical location, the prediction system 130 may select different words for the prediction that may be more likely to correspond to that location. For example, the prediction system 130 may determine that the user 112 is at a hardware store. Based on the user 112 being at the hardware store, the prediction system 130 may generate different predictions than when the user 112 is at a doctor's office or some other location.

In some embodiments, the prediction system 130 may use information regarding the speech disfluency of the user 112 to generate the predictions. For example, a speech therapist or other health care worker may be assisting the user 112 with their speech disfluency. In these and other embodiments, information may be provided by the speech therapist to the prediction system 130. The prediction system 130 may tend to generate predictions that correspond with the information. For example, based on the information the prediction system 130 may generate a first prediction rather than a second prediction that would have been selected without the information.

In some embodiments, the information may relate to words with which a user may have difficulty recalling. For example, a user may have difficulty recalling names of individuals. In this example, the health care worker may input the names of the people with whom the user may interact and how the user is associated with the person. For example, for people within a family of the user, the health care worker may indicate that the names are people within the family. As such, when words related to a family member, such as “I love you,” the prediction may include the names of the family members. In addition, other phrases may be provided after the names such as “so much, a lot, a bunch.” As another example, the health care worker may indicate that the names are people with whom the user associates, such as a doctor. In this example, when words related to the doctor, such as “Hello Doctor,” the predictions may contain names of doctors of the user.

As another example, a user may have difficulty recalling terms associated with a particular interest or hobby of the user. As such, the prediction system 130 may generate predictions directed to the interest or hobby which may be defined by the user or health care worker. For example, the user user may be an avid birder. The health care worker may input words related to birding so that words related to birding may be providing in the prediction where the same words would not be provided otherwise. For example, when the context of speech of the user would not result in the prediction system 130 generating a prediction related to birding, the input from the user or health care worker may result in the prediction including words about birding. For example, the transcription may include the phrase “I saw a,” and the prediction may include the word “bird,” along with other words. Following the previous example, the transcription may follow as “I saw a bird it was a,” and the prediction may include terms that may be used by an avid birder such as “jay, warbler, chickadee, waterfowl, raptor.”

In some embodiments, the prediction system 130 may use historical information to generate the predictions. For example, the prediction system 130 may store data regarding how often a topic is discussed by the user 112. When a transcription appears related to a set of topics, the prediction system 130 may select a topic that is historically used more than other topics for generating the prediction.

In some embodiments, the prediction may not be the exact word to be spoken by the user 112. In these and other embodiments, the prediction may be semantically related words. The semantically related words may assist the user 112 in remembering the exact word to be spoken by the user 112 without providing the exact word. In these and other embodiments, semantically related words may include words that are related conceptually. For example, the word “car” may be semantically related to the words “road,” “driving,” “speed limit,” “freeway,” etc. In these and other embodiments, the prediction system 130 may predict words that may follow the last word in the transcription. In addition, the prediction system 130 may determine words semantically related to the predicted words. In these and other embodiments, the prediction system 130 may provide the semantically related words to the device 110 for presentation to the user. Thus, the prediction may include the words likely to be spoken by the user 112 based on a standard usage of the language of the speech of the user 112 or words semantically related to the words likely to be spoken by the user 112. Standard usage of a language may include word structures with the higher likelihood of occurrence in a language given a contextual foundation.

In some embodiments, when semantically related words are presented to the user 112, the device 110 may or may not present the words that the device 110 expects the user 112 to say. In these and other embodiments, after presenting the semantically related words and not presenting the predicted words, if the user 112 does not say anything for a period of time that satisfies a threshold, the device 110 may present the predicted words in place of the semantically related words to further assist the user 112. The threshold may be selected based on user input, standard pauses in conversations, health condition of the user 112, and feedback from a health practitioner.

In some embodiments, a user may select between have the predictions being predictions of the next words or semantically related words to the next words. In these and other embodiments, the user switch between the predictions being the next words or semantically related words during a transcription. For example, for a first word in a sentence, the user may obtain semantically related words and for a second word in the sentence the user may obtain the predictions of the next words.

Modifications, additions, or omissions may be made to the environment 100 without departing from the scope of the present disclosure. For example, in some embodiments, the prediction system 130 and the transcription system 120 may be part of the device 110. For example, the device 110 may include one or more applications that may be configured to perform the functions of the transcription system 120 and/or the prediction system 130. As such, the example environment 100 may not include the transcription system 120 and/or the prediction system 130.

As another example, the device 110 may perform one or more tasks with respect to generation of the transcription. For example, instead of providing the audio to the transcription system 120, the device 110 may processes the audio to obtain speech data and provide the speech data to the transcription system 120. In these and other embodiments, the transcription system 120 may use the speech data to generate the transcription. Thus, the process of transcription generation may be distributed between the device 110 and the transcription system 120.

As another example, the device 110 may perform one or more tasks with respect to generating the prediction. For example, the device 110 may perform one or more task with respect to generating the prediction and provide the results to the prediction system 130. Thus, the process of prediction generation may be distributed between the device 110 and the prediction system 130.

As another example, the transcription system 120 and the prediction system 130 may be part of the same system. In these and other embodiments, the system may obtain the audio from the device 110 and generate the transcription. In response to obtaining a transcription, the system may provide the transcription to the device 110 and generate a prediction based on the transcription. The system may provide the prediction to the device 110 after generation.

As another example, the transcription system 120 may communicate with the prediction system 130. For example, the transcription system 120 may generate the transcription of audio obtained from the device 110. The transcription system 120 may provide the transcription to the prediction system 130. The prediction system 130 may generate the prediction and send the transcription to the device 110.

Alternately or additionally, the prediction system 130 may generate the prediction and send the prediction to the transcription system 120. In these and other embodiments, the transcription system 120 may provide the prediction to the device 110. In some embodiments, the transcription system 120 may wait to provide the transcription until after receiving the prediction based on the transcription. In these and other embodiments, the transcription system 120 may provide both the transcription and the prediction to the device 110 at the same time. Alternately or additionally, the transcription system 120 may provide the transcription to the device 110 and to the prediction system 130 at the same time and send the prediction to the device 110 after obtaining the prediction from the prediction system 130.

As another example, the example environment 100 may include a second device. The second device may be in communication with the device 110. For example, the second device and the device 110 may be part of a communication session, such as an audio or video communication session. In these and other embodiments, the audio captured by the device 110 may be transcribed and used to obtain the predictions and may be provided to the second device for broadcasting to a second user of the second device. As such, the audio captured by the device 110 may be used for other purposes besides generation of a transcription and obtaining predictions for presentation to the user 112.

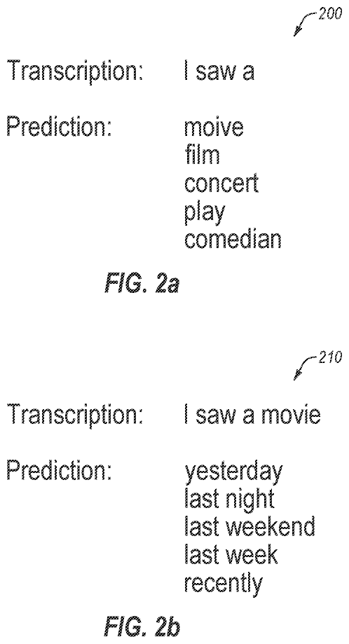

FIGS. 2a and 2b illustrate a first example 200 and a second example 210 of context-based speech assistance. The first example 200 includes a transcription and a prediction. The transcription may include the words “I saw a.” The transcription may include a transcript of speech of a user. The prediction may be generated to include five sets of word. The five sets may each include one word. The words in the sets may include “movie,” “film,” “concert,” play,” and “comedian.” The predictions may be generated using just the word “I saw a,” using context from previous sentences spoken by the user in a current conversation or a current conversation and past conversation, based on words spoken by the user and words spoken by another person, among other data as described in this disclosure.

The user may continue to speak. For example, the user may speak the word “movie.” In response to the user speaking a word that provides context to the speech of the user, the transcription may capture the word and a new prediction may be generated. The second example 210 illustrates the transcription including the word “movie.” Additionally, the prediction may be updated to include a prediction of a word that would follow the last word in the transcription, namely the word “movie,” that was recently spoken. The second example 210 illustrates the prediction including five sets of words. The five sets may each include one word. The words in the sets may include “yesterday,” “last night,” “last weekend,” last week,” and “recently.”

In some embodiments, the prediction may be generated each time that a new word or words is added to the transcription. For example, the transcription may first include “I.” Based on the transcription, a prediction may be generated based on the word “I,” and/or previous words spoken by the user. The transcription may be next updated to include the phrase “I saw a.” The prediction may be updated based on the word “I saw a” and/or previous words spoken by the user. Thus, the prediction may be updated each time that the transcription is updated regardless of actions or speech of the user.

In some embodiments, the prediction may be updated in response to the transcription being updated with a word that provides context to the speech of the user. In these and other embodiments, the prediction may not be updated if the word does not provide context to the speech. A word providing context to the speech may be a word that is expected grammatically in the sentence and provides meaning and structure to the sentence and is more than just a filler word such as uh,” “um,” “like,” or similar words that demonstrate that the user is unsure of what to say. The word not providing context to the speech may indicate that the user is searching for the word and has not said the desired word. As a result, the prediction may not be updated because the user may be trying to determine the next word that provides context to the sentence. For example, a prediction may be provided as illustrated in the first example 200. The user may say a filler word such as “uh,” “um,” “like,” or similar word. In response to the next word not providing additional context to the sentence by describing what was seen, the prediction may not be updated. Note that the if the user says a word that provides context but is not one of the predicted words, the prediction may be updated. For example, the user may say the words “boxing match” instead of one of the predicted words. However, the words “boxing match” provides context to the sentence and thus the prediction is updated.

Modifications, additions, or omissions may be made to the examples without departing from the scope of the present disclosure. For example, in some embodiments, the prediction may include more or fewer sets of words.

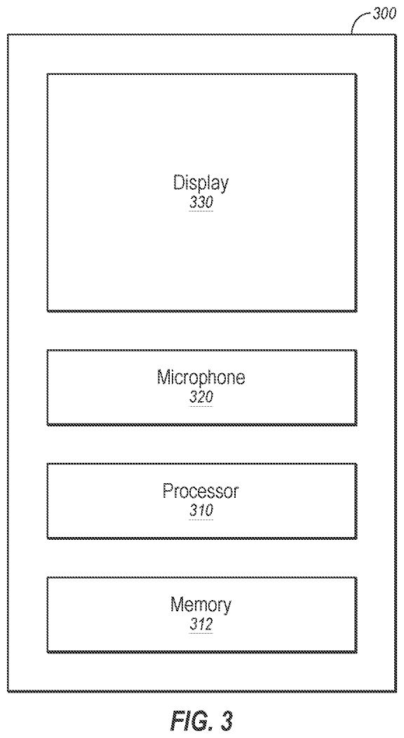

FIG. 3 illustrates an example device 300 used in context-based speech assistance. The device 300 may include one or more processors 310, memory 312, a microphone 320, and a display 330. In some embodiments, the device 300 may be analogous to the device 110 of FIG. 1. Thus, no further description may be provided with respect to FIG. 3 expect where differences may exist. Furthermore, one or more networks, such as the network 102, may communicatively couple the device 300 with other devices and/or systems, such as transcription system and/or a prediction system. For example, the transcription system may be analogous to the transcription system 120 of FIG. 1 and the prediction system may be analogous to the prediction system 130 of FIG. 1.

In some embodiments, the device 300 may be configured to establish a communication session with other devices. For example, the device 300 may be configured to establish an outgoing communication session, such as a telephone call, voice over internet protocol (VOIP) call, video call, or conference call, among other types of outgoing communication sessions, with another device. Alternately or additionally, the device 300 may be configured to establish an incoming communication session with another device.

In some embodiments, the microphone 320 may be configured to obtain audio of a user during a communication session. The microphone 320 may provide the audio to the processors 310. The processors 310 may process the audio following instructions stored in the memory 312. For example, the processors 310 may direct the audio to the transcription system. The transcription system may generate a transcription of the audio and provide the transcription to the device 300. The transcription may be presented on the display 330. In these and other embodiments, second audio of the communication session obtained from another device may also be provided to the transcription system. The transcription system may generate a second transcription of the second audio. The second transcription may be presented on the display 330.

In some embodiments, the transcription and the second transcription may be provided to the prediction system. In these and other embodiments, the prediction system may be configured to generate a prediction using the transcription and the second transcription. The prediction may be of one or more words that may follow the last word in the transcription. The transcription and the second transcription may be used as context to generate the prediction.

As an example, the processors 310 may provide one or more words of the transcription in a command to the prediction system. The command may request that the prediction system provide five words or phrases likely to follow the one or more words of the transcription given the context of the transcription and the second transcription. Further data may also be provided or have been previously provided to the prediction system regarding the user. The prediction system provides the five words or phrases as the prediction to the device 300. The predictions may be presented on the display 330 along with the transcription.

In some embodiments, the predictions may be continuously updated in response to changes to the transcription that occur in response to speech obtained by the microphone 320. For example, as the microphone 320 obtains audio with speech, the audio may be continuously provided to the transcription system. The transcription system may continuously provide updated transcriptions to the device 300 for display as the speech is obtained by the microphone 320. For each word added to the transcription that provides context to the transcription, the prediction may be updated. As such, the prediction may be continuously updated to reflect the prediction of the next word in the transcription as new words are added to the transcription based on speech captured by the microphone 320.

In some embodiments, the predictions may also be updated in response to changes to the second transcription. For example, the second audio may be continuously provided to the transcription system. The transcription system may continuously provide updated second transcriptions to the device 300 for display as the second speech is obtained. For each word added to the second transcription for which a response from the user may be expected and for which a new prediction would be appropriate for the response, the prediction may be updated to words for the user. As such, the prediction may be updated to reflect the prediction of a next word in a conversation based on the second transcription as new words are added to the second transcription based on the second speech.

For example, the transcription may include the phrase “I saw a.” The prediction may include the following words based on the transcription “play, movie, concert, comedian, film.” In response to the transcription including “I saw a” but before the user speaks again, the second transcription may include the words “Oh really?” Based on the second transcription, the prediction may not be updated because the prediction is still be related to the phrase stated by the user and the context of the second transcription may not change the prediction. In response, the user may speak the word “movie” and the transcription may be updated to “I saw a movie.” Based on the update to the transcription, the prediction may be updated to the following words “yesterday, last night, last weekend, last week, recently.” Before further speech by the user, the other person may say “You went to see it early, didn't you?” The second transcription may include this phrase. This question may adjust the context of conversation and an expected response from the user that may be different than the prediction. As a result, the prediction may be updated to include the following words “yesterday, earlier today, this morning, just now, recently.”

In some embodiments, the device 300 may not be participating in a communication session. In these and other embodiments, the microphone 320 may capture audio that may include speech from a first user and a second user. For example, the first user may own the device 300 and may be talking with the second user. The first user may have an application running on the device 300 to perform the operations discussed in the disclosure. The device 300 may distinguish between first speech of the first user and second speech of the second user. For example, the first speech may be distinguished from the second speech based on frequencies, tones, and/or differences between the first speech and the second speech. In these and other embodiments, the device 300 may provide both the first and second speech to the transcription system for a transcription of both the first and second speech. In these and other embodiments, the device 300 may obtain the transcriptions of the first and second speech and may present the transcriptions on the display 330 and provide the transcriptions to the prediction system. In these and other embodiments, the prediction system may only generate a prediction for the transcription of the first speech from the owner of the device 300. The device 300 may present the prediction on the display 330.

Modifications, additions, or omissions may be made to the device 300 without departing from the scope of the present disclosure. For example, in some embodiments, the device 300 may perform one or more of the functions performed by the transcription system and/or the prediction system. For example, in some embodiments, the device 300 may perform all the functions of the transcription system and the prediction system.

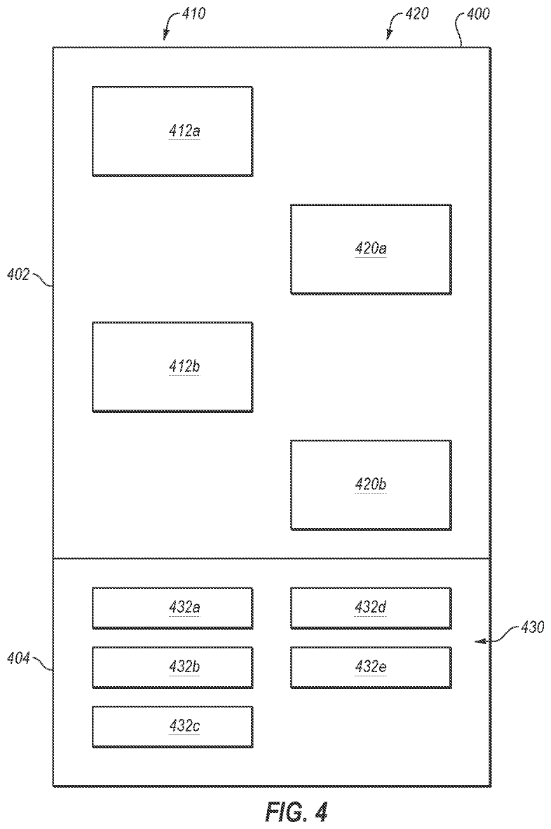

FIG. 4 illustrates an example display 400 used in context-based speech assistance. The display 400 may be part of a device that is associated with a user. For example, the user may have a speech disfluency. The display 400 may include a first area 402 and a second area 404. The first area 402 may be configured to present a first transcription 410 and a second transcription 420. The first transcription 410 may include a first portion 412a and a second portion 412b. The second transcription 420 may include a first portion 420a and a second portion 420b.

In some embodiments, the second transcription 420 may be a transcription of speech of the user associated with the device that includes the display 400. The first transcription 410 may be a transcription of speech of another person. The first transcription 410 and the second transcription 420 may be located on opposites sides of the first area 402 to distinguish therebetween. Further, the portions of the first transcription 410 and the second transcription 420 may represent blocks and an arrangement of when the speech occurred that resulted in the first transcription 410 and the second transcription 420. The current speech may be transcribed and presented in the second portion 420b.

The second area 404 may include a prediction 430. The prediction 430 may include a first word set 432a, a second word set 432b, a third word set 432c, a fourth word set 432d, and a fifth word set 432e, referred to collectively as the word sets 432. The prediction 430 may be a prediction of one or more words that may follow the last word illustrated in the second portion 420b. The word sets 432 may present possible words that may follow the last word in the second portion 420b.

In some embodiments, in response to another word being added to the second portion 420b that adds context to the second transcription 420, the prediction 430 may be updated to reflect a prediction of a word to follow the other word recently added to the second portion 420b.

In some embodiments, the second area 404 may include further functionality. For example, in some embodiments, each of the word sets 432 may be selectable. In response to being selected, the word sets 432 may perform one or more functions. For example, in some embodiments, in response to being selected, the words in the selected word set 432 may be broadcast by a microphone associated with the device. Thus, the user of the device may not need to vocalize the words in the word sets 432. In these and other embodiments, the selecting one of the word sets 432, may result in the transcription being updated with the words from the selected word set 432.

As another example, in response to a word set 432 being selected, further information about the words in the selected word set 432 may be presented. For example, a definition, one or more semantically related words, or other information about the words in the selected word set may be presented on the display 400. In these and other embodiments, a user interacting with a word set 432 and how the user interacts with the word set 432 may be used by a prediction system to generate predictions in the future for the user. For example, the selection of a word set 432 may indicate a preference of the user for the words in the word set given the context of the current second transcription 420. As such, the prediction system may suggest the words in the selected word set 432 when the context of the current second transcription 420 occurs again.

In some embodiments, multiple functions associated with a selected word set may be available. For example, in response to selection of a word set 432, the different functions associated with the selected word set may be presented and one or more of the functions may be selected.

Modifications, additions, or omissions may be made to the display 400 without departing from the scope of the present disclosure. For example, in some embodiments, the shape and/or the arrangement of the first area 402 and the second area 404 may be different. Alternately or additionally, the shape and arrangement of the first transcription 410, the second transcription 420, and the word sets 432 may be different. As another example, more or less than five word sets 432 may be presented in the second area 404.

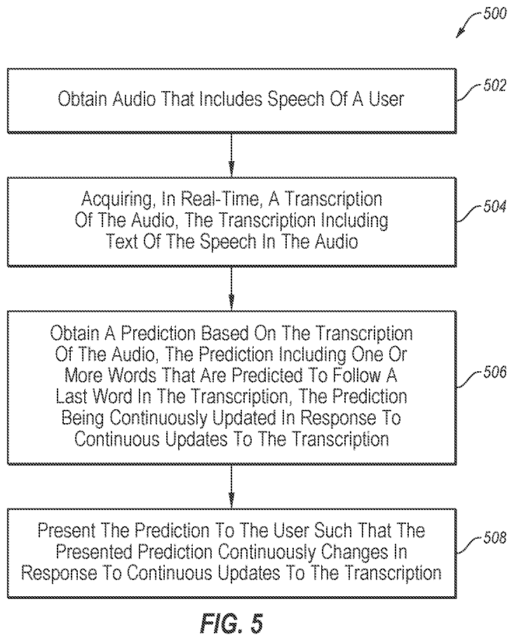

FIG. 5 illustrates a flowchart of an example method 500 for context-based speech assistance. The method 500 may be arranged in accordance with at least one embodiment described in the present disclosure. One or more operations of the method 500 may be performed, in some embodiments, by a device or system, such as the device 110 of FIG. 1 or another device or combination of devices. In these and other embodiments, the method 500 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 500 may begin at block 502, where audio may be obtained that includes speech of a user. The speech may include speech of a user, such as a person with speech disfluency. The speech may also include speech of one or more other people.

At block 504, a transcription of the audio may be acquired in real-time. The transcription may include text of the speech in the audio. Thus, the transcription may include text of the speech of the user or text of the speech of the other people. In these and other embodiments, the transcription may distinguish between the text of the speech of the user and the text of the speech of the other person.

At block 506, a prediction may be obtained based on the transcription of the audio. The prediction may include one or more words that are predicted to follow a last word in the transcription. The prediction may be continuously updated in response to continuous updates to the transcription. The updates to the transcription may be based on speech by the user or speech by another person.

In some embodiments, the one or more words of the prediction may be words likely to follow the last word in the transcription based on standard usage of a language of the speech. Alternately or additionally, the one or more words of the prediction may be words semantically related to a word that likely follows the last word in the transcription based on standard usage of a language of the speech.

At block 508, the prediction may be presented to the user such that the presented prediction continuously changes in response to continuous updates to the transcription. In some embodiments, the prediction may be presented to the user until the transcription includes another word that provides context to the speech of the user. For example, the other word may be another word spoken by the user or another person. In some embodiments, the prediction may be generated based on data provided by a health practitioner assisting the user.

In some embodiments, the prediction may include multiple word sets. Each of the word sets may include one or more words. In these and other embodiments, the presenting the prediction may include presenting the word sets. In some embodiments, a number of the word sets may include at least five.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For example, the method 500 may further include obtaining input from the user that selects one of the word sets and in response to the input, presenting further data regarding the selected one of the word sets.

As another example, the method 500 may include presenting the transcription of the speech in real-time in addition to the presentation of the prediction. In these and other embodiments, the method 500 may further include obtaining second audio that includes speech of a third person and acquiring, in real-time, a second transcription of the second audio. The second transcription may include text of the speech of the third person in the second audio. The method 500 may also include presenting the second transcription, the transcription, and the prediction to the user.

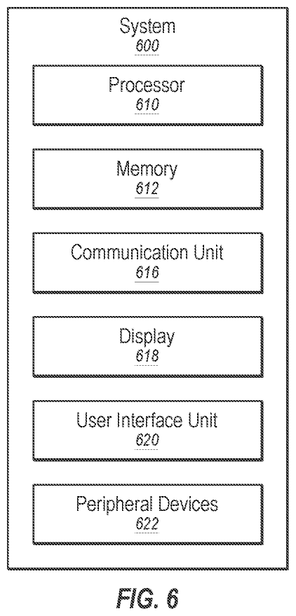

FIG. 6 illustrates an example system 600 that may be used during transcription presentation. The system 600 may be arranged in accordance with at least one embodiment described in the present disclosure. The system 600 may include a processor 610, memory 612, a communication unit 616, a display 618, a user interface unit 620, and a peripheral device 622, which all may be communicatively coupled. In some embodiments, the system 600 may be part of any of the systems or devices described in this disclosure.

For example, the system 600 may be part of the device 110 of FIG. 1 and may be configured to perform one or more of the tasks described above with respect to the device 110. Alternately or additionally, the system 600 may be part of the transcription system 120 and/or the prediction system 130 of FIG. 1

Generally, the processor 610 may include any suitable special-purpose or general-purpose computer, computing entity, or processing device including various computer hardware or software modules and may be configured to execute instructions stored on any applicable computer-readable storage media. For example, the processor 610 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 6, it is understood that the processor 610 may include any number of processors distributed across any number of networks or physical locations that are configured to perform individually or collectively any number of operations described herein. In some embodiments, the processor 610 may interpret and/or execute program instructions and/or process data stored in the memory 612. In some embodiments, the processor 610 may execute the program instructions stored in the memory 612.

For example, in some embodiments, the processor 610 may execute program instructions stored in the memory 612 that are related to transcription presentation such that the system 600 may perform or direct the performance of the operations associated therewith as directed by the instructions. In these and other embodiments, the instructions may be used to perform the method 500 of FIG. 5.

The memory 612 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 610.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store particular program code in the form of computer-executable instructions or data structures and which may be accessed by a general-purpose or special-purpose computer. Combinations of the above may also be included within the scope of computer-readable storage media.

Computer-executable instructions may include, for example, instructions and data configured to cause the processor 610 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The communication unit 616 may include any component, device, system, or combination thereof that is configured to transmit or receive information over a network. In some embodiments, the communication unit 616 may communicate with other devices at other locations, the same location, or even other components within the same system. For example, the communication unit 616 may include a modem, a network card (wireless or wired), an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, etc.), and/or the like. The communication unit 616 may permit data to be exchanged with a network and/or any other devices or systems described in the present disclosure.

The display 618 may be configured as one or more displays, like an LCD, LED, Braille terminal, or other type of display. The display 618 may be configured to present video, text captions, user interfaces, and other data as directed by the processor 610.

The user interface unit 620 may include any device to allow a user to interface with the system 600. For example, the user interface unit 620 may include a mouse, a track pad, a keyboard, buttons, camera, and/or a touchscreen, among other devices. The user interface unit 620 may receive input from a user and provide the input to the processor 610. In some embodiments, the user interface unit 620 and the display 618 may be combined.

The peripheral devices 622 may include one or more devices. For example, the peripheral devices may include a microphone, an imager, and/or a speaker, among other peripheral devices. In these and other embodiments, the microphone may be configured to capture audio. The imager may be configured to capture images. The images may be captured in a manner to produce video or image data. In some embodiments, the speaker may broadcast audio received by the system 600 or otherwise generated by the system 600.

Modifications, additions, or omissions may be made to the system 600 without departing from the scope of the present disclosure. For example, in some embodiments, the system 600 may include any number of other components that may not be explicitly illustrated or described. Further, depending on certain implementations, the system 600 may not include one or more of the components illustrated and described.

As indicated above, the embodiments described herein may include the use of a special purpose or general-purpose computer (e.g., the processor 610 of FIG. 6) including various computer hardware or software modules, as discussed in greater detail below. Further, as indicated above, embodiments described herein may be implemented using computer-readable media (e.g., the memory 612 of FIG. 6) for carrying or having computer-executable instructions or data structures stored thereon.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

1. A method comprising:
obtaining audio that includes speech of a user;
acquiring, in real-time, a transcription of the audio, the transcription including text of the speech in the audio;
obtaining a prediction based on the transcription of the audio, the prediction including one or more words that are predicted to follow a last word in the transcription, the prediction being continuously updated in response to continuous updates to the transcription; and
presenting the prediction to the user such that the presented prediction continuously changes in response to continuous updates to the transcription.

2. The method of claim 1, wherein the prediction is presented to the user until the transcription includes another word that provides context to the speech of the user.

3. The method of claim 1, wherein the prediction includes a plurality of word sets, each of the plurality of word sets including one or more words and the presenting the prediction includes presenting the plurality of word sets.

4. The method of claim 3, wherein a number of the plurality of word sets includes at least five.

5. The method of claim 3, further comprising:
obtaining input from the user that selects one of the plurality of word sets; and
in response to the input, presenting further data regarding the selected one of the plurality of word sets.

6. The method of claim 1, wherein the one or more words of the prediction are words likely to follow the last word in the transcription based on standard usage of a language of the speech.

7. The method of claim 1, wherein the one or more words of the prediction are words semantically related to a word that likely follows the last word in the transcription based on standard usage of a language of the speech.

8. The method of claim 1, wherein the prediction is generated based on data provided by a health practitioner assisting the user.

9. The method of claim 1, further comprising presenting the transcription of the speech in real-time in addition to the presentation of the prediction.

10. The method of claim 9, further comprising:
obtaining second audio that includes speech of a third person;
acquiring, in real-time, a second transcription of the second audio, the second transcription including text of the speech of the third person in the second audio; and
presenting the second transcription, the transcription, and the prediction to the user.

11. One or more computer readable media configured to store instructions, which when executed, are configured to cause performance of the method of claim 1.

12. A device comprising:
a microphone configured to capture audio that includes speech of a user;
a display;
one or more computer readable media configured to store instructions; and
one or more processors coupled to the microphone, the display, and the one or more computer readable media, the one or more processors configured to execute the instructions to cause the device to perform operations, the operations comprising:
acquire, in real-time, a transcription of the audio, the transcription including text of the speech in the audio;
obtain a prediction based on the transcription of the audio, the prediction including one or more words that are predicted to follow a last word in the transcription, the prediction being continuously updated in response to continuous updates to the transcription; and
direct the display to present the prediction to the user such that the presented prediction continuously changes in response to continuous updates to the transcription.

13. The device of claim 12, wherein the prediction is presented to the user until the transcription includes another word that provides context to the speech of the user.

14. The device of claim 12, wherein the prediction includes a plurality of word sets, each of the plurality of word sets including one or more words and the presenting the prediction includes presenting the plurality of word sets.

15. The device of claim 14, wherein a number of the plurality of word sets includes at least five.

16. The device of claim 14, wherein the operations further comprise:
obtain input from the user that selects one of the plurality of word sets; and
in response to the input, direct the display to present further data regarding the selected one of the plurality of word sets.

17. The device of claim 12, wherein the one or more words of the prediction are words likely to follow the last word in the transcription based on standard usage of a language of the speech.

18. The device of claim 12, wherein the one or more words of the prediction are words semantically related to a word that likely follows the last word in the transcription based on standard usage of a language of the speech.

19. The device of claim 12, wherein the prediction is generated based on data provided by a health practitioner assisting the user.

20. The device of claim 12, wherein the operations further comprise direct the display to present the transcription of the speech in real-time in addition to the presentation of the prediction.
